(19) United States
(12) Patent Application Publication
(10) Pub. No.: US 2026/0085264 A1
(43) Pub. Date: Mar. 26, 2026

(54) DISSOLVABLE CLEANSING STRIPS FOR CLEANING, DISINFECTING, OR STERILIZING HEALTHCARE DEVICES

(71) Applicant: COLTENE/WHALEDENT, INC., Cuyahoga Falls, OH (US)

(72) Inventors: Jeffrey Scott WRIKEMAN, Seven Hills, OH (US); Tricia Ann CREGGER, Fairlawn, OH (US)

(21) Appl. No.: 19/407,536

(22) Filed: Dec. 3, 2025

Related U.S. Application Data
(63) Continuation of application No. PCT/US2024/031430, filed on May 29, 2024.
(60) Provisional application No. 63/506,201, filed on Jun. 5, 2023.

(51) Int. Cl. C11D 17/04; C11D 1/02; C11D 1/66; C11D 1/83; C11D 3/37

(52) U.S. Cl. CPC C11D 17/049; C11D 1/02; C11D 1/662; C11D 1/83; C11D 3/3707

(57) ABSTRACT

A water-soluble dissolvable cleansing strip comprising a water-soluble carrier film; and cleansing chemistry coated upon or embedded within the water-soluble carrier film, wherein the cleansing chemistry comprises at least one active ingredient selected from the group consisting of sodium tetraborate pentahydrate, an alkylpolyglycoside, ortho-benzyl-para-chlorophenol, para-tertiary amylphenol, 2-phenylphenol, and any combination thereof. Methods include cleansing a healthcare device with one or more water-soluble dissolvable cleansing strips.

### CROSS-REFERENCE TO RELATED APPLICATIONS

This application is a continuation of international application PCT/US2024/031430, filed May 29, 2024, which claims priority to and the benefit of provisional application 63/506,201, filed Jun. 5, 2023, the disclosures of which are incorporated herein by reference.

### FIELD OF INVENTION

This application relates to water-soluble dissolvable cleansing strips, and methods related thereto, specifically for use in the medical and dental industries for cleaning, disinfecting, or sterilizing medical and dental devices.

### BACKGROUND

In the medical and dental healthcare industries, a variety of instruments and equipment (collectively “healthcare devices” herein) are used on a daily basis during surgery or other aseptic procedures in the normal operation of healthcare facilities, such as hospitals, clinics, and healthcare provider offices. When such healthcare devices are not pre-packaged in a disinfected or sterile state, they must be disinfected or sterilized before use. Moreover, when such devices are not disposable and are used more than once, they must be cleaned, disinfected or sterilized, and otherwise prepared for subsequent use.

As used herein, and for ease of description, the term “cleanse” or “cleansing,” and grammatical variants thereof, will collectively refer to “cleaning” (i.e., removing dirt, dust, and other organic matter from surfaces), “disinfecting” (i.e., eliminating bacteria and viruses from surfaces), and “sterilizing” (i.e., eliminating all microorganisms from surfaces).

Current cleansing of healthcare devices involve the use of bottled cleansing solutions or cleansing tablets. Bottled cleansing solutions require a significant amount of packaging, significant storage space, and result in a substantial amount of packaging waste. Moreover, bottled cleansing solutions require an operator to measure an amount of solution for each cleansing occurrence. Cleansing tablets advantageously reduce the amount of packaging, storage space, and packaging waste compared to bottled cleansing solutions, but require a relatively long time to dissolve in order to deliver cleansing chemistries to healthcare devices during a cleansing operation.

There is a need for a healthcare cleansing product with reduced packaging, reduced storage space requirements, and reduced waste creation, which can further quickly deliver cleansing chemistries during healthcare device cleansing operations.

### SUMMARY OF INVENTION

In one or more aspects, the present disclosure provides a method of cleansing a healthcare device. A water-soluble dissolvable cleansing strip is provided including a water-soluble carrier film; and cleansing chemistry coated upon or embedded within the water-soluble carrier film, wherein the cleansing chemistry comprises at least one active ingredient selected from the group consisting of sodium tetraborate pentahydrate, an alkylpolyglycoside, ortho-benzyl-para-chlorophenol, para-tertiary amylphenol, 2-phenylphenol, and any combination thereof. The water-soluble dissolvable cleansing strip is introduced and dissolved in an aqueous-based fluid to release the cleansing chemistry. The cleansing chemistry is used to cleanse a healthcare device soaking in the aqueous-based fluid.

In one or more aspects, the present disclosure provides a water-soluble dissolvable cleansing strip including a water-soluble carrier film; and cleansing chemistry coated upon or embedded within the water-soluble carrier film, wherein the cleansing chemistry comprises at least one active ingredient selected from the group consisting of sodium tetraborate pentahydrate, an alkylpolyglycoside, ortho-benzyl-para-chlorophenol, para-tertiary amylphenol, 2-phenylphenol, and any combination thereof. The water-soluble, dissolvable cleansing strip is dissolvable in an aqueous-based fluid to cleanse a healthcare device soaking therein.

These and other features and attributes of the disclosed water-soluble dissolvable cleansing strips, and their advantageous applications and/or uses for cleansing healthcare devices will be apparent from the detailed description which follows.

### DETAILED DESCRIPTION

This application relates to water-soluble dissolvable cleansing strips, and methods related thereto, specifically for use in the medical and dental industries for cleaning, disinfecting, or sterilizing medical and dental devices.

As described above, it is necessary to cleanse (including clean, disinfect, or sterilize) healthcare devices for use in the healthcare (i.e., medical and dental) industry. Current cleansing products used in the healthcare industry suffer from at least one or more of a significant amount of packaging, storage space requirements, generation of a substantial amount of packaging waste, and/or relatively high operational time requirements to deliver cleaning chemistry to a healthcare device. The present disclosure addresses at least these issues, and provides other advantages.

The present disclosure provides economical and environmentally friendly dissolvable cleansing strips for cleansing healthcare devices, are designed to deliver specific, unit dosing (i.e., correct) of cleansing chemistry to healthcare devices per each dissolvable cleansing strip or plurality of dissolvable cleansing strips. The dissolvable cleansing strips can be used to initially cleanse and/or cleanse during reprocessing of healthcare devices, and provide fast-acting dissolution and release of concentrated cleansing chemistries compared to current healthcare cleansing tablets due to their high surface area and chemistry release (i.e., not pressed into a solid tablet). The dissolvable cleansing strips are in the form of a water-soluble solid, small in size, and lightweight. As such, the dissolvable cleansing strip packaging is likewise small in size and lightweight, thereby reducing packaging amount and packaging waste, as well as reducing storage space in healthcare facilities, compared to current healthcare bottled cleansing solutions and cleansing tablets. Moreover, the aforementioned qualities can reduce transportation costs associated with shipping the dissolvable cleansing strips. The protective packaging for the dissolvable cleansing strips of the present disclosure may be composed of recycled materials that are partially or wholly (100%) recyclable, compostable, and/or biodegradable. In one or more instances, the protective packaging is at least 100% recyclable and biodegradable.

The dissolvable cleansing strips of the present disclosure comprise at least a water-soluble solid carrier film including cleansing chemistry comprising at least one or more concentrated cleansing active ingredients. As described herein, the dissolvable cleansing strips described herein may further include one or more additives, such as a thickener, a surfactant, a preservative, and any combination thereof. Cleansing of healthcare devices using the dissolvable cleansing strips of the present disclosure may be in the form of soaking, with or without agitation, after removal from their protective packaging.

### DEFINITIONS

As used in the present disclosure and claims, the singular forms “a,” “an,” and “the” include plural forms unless the context clearly dictates otherwise.

The term “and/or” as used in a phrase such as “A and/or B” herein is intended to include “A and B,” “A or B,” “A,” and “B.”

For the purposes of the present disclosure and the claims thereto, the following definitions shall be used.

As provided above and as used herein, the term “cleanse” or “cleansing,” and grammatical variants thereof, refers collectively to “cleaning” (i.e., removing dirt, dust, and other organic matter from surfaces), “disinfecting” (i.e., eliminating bacteria and viruses from surfaces), and “sterilizing” (i.e., eliminating all microorganisms from surfaces). Cleansing includes removal of organic matter, such as blood, blood constituents, blood proteins, albumin, hemoglobin, bone fragments (including teeth), cartilage, bone marrow, tartar, fibrin, and the like, and any combination thereof.

As used herein, the term “healthcare device,” and grammatical variants thereof, refers to instruments and equipment used in the medical and dental industries, collectively referred to herein as the “healthcare industry.”

As used herein, the term “healthcare facility,” and grammatical variants thereof, refers to a medical or dental facility in which cleansing of healthcare devices prior to initial use or upon reprocessing is required.

As used herein, the term “unit dose,” and grammatical variants thereof, refers to an amount of cleansing chemistry as part of a single dissolvable cleansing strip, which is packaged in a non-reusable container; each container comprising multiple unit dose strips. The unit dose amount may vary depending on the concentration of cleansing chemistry present in a single dissolvable cleansing strip or the dimensions of the dissolvable cleansing strip.

As used herein, the term “water-soluble dissolvable cleansing strip,” or simply “dissolvable cleansing strip,” and grammatical variants thereof, refers to a sized water-soluble carrier film comprising cleansing chemistry applied thereon or therewithin and comprising a specific unit dose, as described hereinbelow.

As used herein, the term “cleansing chemistry,” and grammatical variants thereof, refers to at least one or more active ingredients capable of directly effecting the cleansing (cleaning, disinfecting, or sterilizing) of a healthcare device.

As used herein, the terms “soak” or “soaking,” and grammatical variants thereof, refers to wetting and washing, by immersion or partial immersion, of a healthcare device in the presence of one or more dissolvable cleansing strips described herein for a period of time.

As used herein, the term “agitation,” and grammatical variants thereof, refers to circulation of a liquid, such as by shaking, mixing, bubbling, or a combination thereof.

As used herein, the term “cleansing solution,” and grammatical variants thereof, refers to an aqueous solution comprising an aqueous-based fluid and one or more dissolvable cleansing strips of the present disclosure, in which the dissolvable cleansing strips are partially or wholly dissolved.

### Dissolvable Cleansing Strip Cleansing Chemistry

The dissolvable cleansing strips of the present disclosure comprise at least a water-soluble solid carrier film including cleansing chemistry comprising at least one or more concentrated cleansing active ingredients.

The water-soluble solid carrier film may include a water-soluble polymer including, but not limited to, partially or fully (100%) dissolved in an aqueous-based fluid to release the active ingredient(s) coated or contained within the carrier film. Suitable water-soluble polymers may include, but are not limited to, an alcohol polymer (e.g., polyvinyl alcohol, polyvinyl glycol, and the like); a polyacrylamide; a cellulose derivative (e.g., micro-crystalline cellulose; hydroxypropylcellulose, hydroxypropylmethylcellulose, hydroxyethylcellulose, methylcellulose, carboxymethylcellulose, sodium carboxymethylcellulose, and the like); a polyvinylpyrrolidone; an acrylate polymer (e.g., sodium polyacrylate, acrylic homopolymers and copolymers, copolymers of acrylamide and sodium acrylate, and the like); a sorbitol; a seaweed; a synthetic polymer (e.g., polymethylvinylether (PVME), poly-(2-ethyl2-oxazoline), and the like); a polyethyleneimine; and the like; or any combination thereof. In preferred aspects, the water-soluble solid carrier film is a polyvinyl alcohol, a polyethylene glycol (e.g., PEG4000, PEG6000), a polyacrylamide, a polyacrylic acid, or any combination thereof.

The active ingredient(s) form at least a portion of the cleansing chemistry, the cleansing chemistry being coated upon or otherwise embedded within the water-soluble carrier film to form the dissolvable cleansing strips described herein. Suitable active ingredients may include, but are not limited to, one or more of sodium tetraborate pentahydrate, an alkylpolyglycoside, ortho-benzyl-para-chlorophenol, para-tertiary amylphenol, 2-phenylphenol, and combinations thereof. In one or more aspects, the active ingredients in a dissolvable cleansing strip may comprise a combination of at least sodium tetraborate pentahydrate and an alkylpolyglycoside; a combination of at least ortho-benzyl-para-chlorophenol, para-tertiary amylphenol, and 2-phenylphenol; a combination of sodium percarbonate, water, and buffering agent(s) (thereby producing hydrogen peroxide); or a combination of sodium perborate, aspirin (salicylic acid), and buffering agent (thereby producing peracetic acid). For enzymatic dissolvable cleansing strips suitable enzymes may include proteases, amylases, lipases, cellulases, mannanases, and pectinases, and any combination thereof. Suitable commercially available active ingredients include, but are not limited to, BIOSONIC® UC30, UC32, and UC42 (Coltene/Whaledent, Inc., Altstatten, Switzerland).

In one or more aspects, the active ingredient(s) may be present in an amount in the range of about 0.2 percent weight by total weight (w/w %) of the cleansing chemistry (e.g., including any additives) to about 60 w/w %, such as about 1 w/w % to about 50 w/w %, or about 1 w/w % to about 40 w/w %, encompassing any value and subset therebetween.

The cleansing chemistry may further comprise one or more additives, such as thickeners, surfactants, and any combination thereof. Suitable thickeners may include, but are not limited to, polypropylene glycol, an alginate (e.g., sodium alginate, and the like); a glycerin; a protein (e.g., whey, soy, collagen, gelatin, wheat gluten, milk proteins, and the like); a gum (e.g., guar gum, locust gum, tara gum, agar gum, xanthan gum, and the like); a polysaccharide (e.g., starches (i.e., natural and chemically modified), chitosan, maltodextrin, pectin, xanthan gum, guar gum, gum arabic, algin, pullulan, and the like); suitable surfactants may include, but are not limited to, an alkyl polyglycoside, a sodium tetraborate, ethanolamine, and any combination thereof; suitable preservatives may include, but are not limited to, diazolidinyl urea, a paraben, sodium benzoate, lactic acid, isothiazolones, bronopol, and any combination thereof. The cleansing chemistry typically includes water and isopropyl alcohol, the isopropyl alcohol being less than about 10% by volume of the cleansing chemistry, such as less than about 5% by volume.

In one or more aspects, the additive(s) may be present in an amount in the range of about 0.1 w/w % of the cleansing chemistry to about 50 w/w %, such as about 0.2 w/w % to about 40 w/w %, or about 0.4 w/w % to about 30 w/w %, encompassing any value and subset therebetween.

As described above, the cleansing chemistry may be coated upon or otherwise embedded within the water-soluble carrier film to form the dissolvable cleansing strips described herein. After coating or embedding, in one or more aspects, the dissolvable cleansing strips are treated to remove excess moisture (e.g., water) therefrom, such as by the application of heat or air drying, for example.

### Dissolvable Cleansing Strip Physical Properties

The size and thickness of the dissolvable cleansing strips are not considered to be particularly limiting. In one or more aspects, the size of the dissolvable strips may be achieved from cutting larger sheets of the water-soluble carrier film, and after cutting, applying the cleansing chemistry. In one or more instances, the length of each dissolvable cleansing strip may be in the range of about 5 centimeters (cm) to about 20 cm, such as about 10 cm to about 20 cm, or about 15 cm to about 20 cm, encompassing any value and subset therebetween; the width of each dissolvable cleansing strip may be in the range of about 5 cm to about 15 cm, such as about 5 cm to about 10 cm, or about 10 cm to about 15 cm, encompassing any value and subset therebetween; and the thickness of dissolvable cleansing strip may be in the range of about 1 millimeter (mm) to about 20 mm, such as about 2 mm to about 15 mm, or about 5 mm to about 10 mm, encompassing any value and subset therebetween.

The shape of the dissolvable cleansing strips are not considered to be particularly limiting. Generally, the shape of the dissolvable cleansing strips is rectangular or square. However, the shape of the dissolvable cleansing strips may be other shapes, such as circular, oval, triangular, polygonal, and the like, without departing from the scope of the present disclosure.

As described above, the dissolvable cleansing strips are lightweight and may have a weight in the range of about 0.1 gram (g) to about 100 g, or about 2 g to about 50 g, or about 2 g to about 25 g, encompassing any value and subset therebetween.

The color of the dissolvable cleansing strips is not considered to be particularly limiting. For example, the color of the dissolvable cleansing strips may be transparent, translucent, opaque, white, or colored, without departing from the scope of the present disclosure.

The dissolvable cleansing strips may be wholly solid or perforated. Without being bound by theory, it is believed that perforated dissolvable cleansing strips may assist with controlled dissolution time.

### Healthcare Devices

Healthcare devices that may be cleansed using the dissolvable cleansing strips of the present disclosure are not considered to be particularly limited, provided that they are composed of a material compatible with the selected active ingredient of the dissolvable cleansing strip(s). Examples of healthcare devices include instruments and equipment that can be soaked or washed in an aqueous-based fluid (e.g., water). Specific examples of healthcare devices that may be cleansed using the dissolvable cleansing strips of the present disclosure include, but are not limited to, diagnostic instruments or components thereof, gouges, trays, endoscopes, arthroscopes, stents, plugs, cannulas, scoops, trays, punches, dental plyers, dental burs, scaler inserts, rongeurs, keratomes, forceps, scissors, saws (e.g., bone saws), saw blades, tweezers, racks, pans, beakers, drills, drill pits, chisels, knives, curettes, retractors, glassware, catheters, tubing, mouth mirrors, scrapers (e.g., sickle scraper), gum cleaners, dental probes, and the like, and any combination thereof.

Such healthcare devices are used in a variety of healthcare facilities, such as hospitals (e.g., CSC units), medical clinics, dental clinics, ambulatory centers, healthcare provider offices, and the like, and combinations thereof.

### Cleansing Methods

The healthcare devices of the present disclosure may be cleansed using a healthcare cleansing system, such as by soaking with or without the application of agitation. In one or more aspects, the agitation is achieved by shaking, mixing, and/or bubbling. In particular aspects, agitation is partially or wholly achieved using ultrasonic agitation or by use of a non-ultrasonic washer (e.g., a cart or cage washer, glass machine washer, dip agitation washer, and the like).

Soaking, with or without agitation, may be performed, for example, within a container (e.g., tank, sink, or other enclosure) comprising an aqueous-based fluid (e.g., water) having a target volume into which one or more unit doses of the dissolvable cleansing strips is added. The aqueous-based fluid volume and number of unit doses (one or more) of the dissolvable cleansing strips is included to achieve a desired concentration of cleansing chemistry in the resultant cleansing solution. The one or more unit doses of dissolvable cleansing strips may be added (i.e., removed from environmentally friendly packaging) to the aqueous-based fluid either before or after introducing one or more healthcare device(s) to the container, without departing from the scope of the present disclosure. As provided above, in some instances, the container is an ultrasonic container, such as BIOSONIC® Ultrasonic Cleaners UC150 and UC300 (Coltene/Whaledent, Inc., Cuyahoga Falls, OH). In other instances, the container is a washer. In yet other instances, the healthcare device(s) are cleansed manually.

Soaking may be performed, after partial or complete dissolution of the one or more dissolvable cleansing strips, for a period of time sufficient to effectively cleanse the healthcare device(s), depending on the soiling of the healthcare device(s). Dissolution of the dissolvable cleansing strips typically occurs within about 5 seconds to about 5 minutes, depending on the desired concentration of active ingredient cleansing chemistry of the cleansing solution, encompassing any value and subset therebetween. Soaking time of the healthcare device(s) may be in the range of at least about 1 minute and up to 24 hours (e.g., overnight), encompassing any value and subset therebetween and may be at a temperature in the range of about 20° C. to about 80° C., encompassing any value and subset therebetween. In some aspects, soaking occurs at room temperature (RT), or about 20° C.

The concentration of active ingredient cleansing chemistry in the cleansing solution will depend upon the soiling of the healthcare device(s), the judgment of the operator, the soaking time and temperature, the presence or absence of agitation, and the like, and any combination thereof. The concentration of active ingredient cleansing chemistry in the cleansing solution, after dissolution of the dissolvable cleansing strip(s), may be in the range of about 0.1% to about 25%, encompassing any value and subset therebetween.

Accordingly, the present disclosure provides economical and environmentally friendly dissolvable cleansing strips for cleansing healthcare devices, are designed to deliver specific, unit dosing (i.e., correct) of cleansing chemistry to healthcare devices per each dissolvable cleansing strip or plurality of dissolvable cleansing strips.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### EXAMPLE EMBODIMENTS

Nonlimiting example embodiments of the present disclosure include:
Embodiment A: A method of cleansing a healthcare device comprising: providing a water-soluble, dissolvable cleansing strip comprising: a water-soluble carrier film; and cleansing chemistry coated upon or embedded within the water-soluble carrier film, wherein the cleansing chemistry comprises at least one active ingredient selected from the group consisting of sodium tetraborate pentahydrate, an alkylpolyglycoside, ortho-benzyl-para-chlorophenol, para-tertiary amylphenol, 2-phenylphenol, and any combination thereof; introducing the water-soluble dissolvable cleansing strip to an aqueous-based fluid; dissolving the water-soluble dissolvable cleansing strip in the aqueous-based fluid, thereby releasing the cleansing chemistry into the aqueous-based fluid; soaking the healthcare device in the aqueous-based fluid comprising the released cleansing chemistry, thereby cleansing the healthcare device.
Embodiment B: A water-soluble dissolvable cleansing strip comprising: a water-soluble carrier film; and cleansing chemistry coated upon or embedded within the water-soluble carrier film, wherein the cleansing chemistry comprises at least one active ingredient selected from the group consisting of sodium tetraborate pentahydrate, an alkylpolyglycoside, ortho-benzyl-para-chlorophenol, para-tertiary amylphenol, 2-phenylphenol, and any combination thereof, wherein the water-soluble dissolvable cleansing strip is dissolvable in an aqueous-based fluid to cleanse a healthcare device soaking therein.

Nonlimiting example Embodiments A or B may include one or more of the following Elements:
Element 1: wherein the healthcare device is a medical device or a dental device.
Element 2: wherein the at least one active ingredient comprises a combination of at least sodium tetraborate pentahydrate and an alkylpolyglycoside.
Element 3: wherein the at least one active ingredient comprises a combination of at least ortho-benzyl-para-chlorophenol, para-tertiary amylphenol, and 2-phenylphenol.
Element 4: wherein the water-soluble carrier film is selected from the group consisting of an alcohol polymer, a polyacrylamide, a cellulose derivative, a polyvinylpyrrolidone, an acrylate polymer, an alginate, a glycerin, a protein, a gum, a polysaccharide, a sorbitol, a seaweed, a synthetic polymer, a polystyrene sulfonate, a polyampholyte, a polyethyleneimine, and any combination thereof.
Element 5: wherein the water-soluble carrier film is selected from the group consisting of a polyvinyl alcohol, a polyethylene glycol, a polyacrylamide, a polyacrylic acid, and any combination thereof.
Element 6: wherein the at least one active ingredient is present in an amount in the range of about 0.2 percent weight by total weight of the cleansing chemistry to about 10 percent weight by total weight of the cleansing chemistry.
Element 7: wherein the cleansing chemistry further comprises at least one additive selected from the group consisting of a thickener, a surfactant, a preservative, and any combination thereof.
Element 8: wherein the cleansing chemistry further comprises at least one additive selected from the group consisting of a thickener, a surfactant, a preservative, and any combination thereof, and the at least one additive is present in an amount in the range of about 0.1 percent weight by total weight of the cleansing chemistry to about 5 percent weight by total weight of the cleansing chemistry.
Element 9: wherein the cleansing chemistry comprises a thickener and the thickener is polypropylene glycol.
Element 10: wherein the cleansing chemistry comprises a surfactant and the surfactant is selected from the group consisting of an alkyl polyglycoside, a sodium tetraborate, ethanolamine, and any combination thereof.
Element 11: wherein the cleansing chemistry comprises a preservative and the preservative is selected from the group consisting of diazolidinyl urea, a paraben, and any combination thereof.
Element 12: further comprising removing the water-soluble dissolvable cleansing strip from a protective packaging.
Element 13: further comprising removing the water-soluble dissolvable cleansing strip from a protective packaging, wherein the protective packaging is 100% recyclable and biodegradable.
Element 14: wherein the water-soluble dissolvable cleaning strip is contained within a protecting packaging.
Element 15: wherein the water-soluble dissolvable cleaning strip is contained within a protecting packaging, and wherein the protective packaging is 100% recyclable and biodegradable.

Exemplary combinations applicable to Embodiment A include one or more of the following Elements: any one, more, or all of Elements 1, 2, 4, and 6-13; any one, more, or all of Elements 1, 3, 4, and 6-13; any one, more, or all of Elements 1, 2, 5, and 6-13; any one, more, or all of Elements 1, 3, 5, and 6-13.

or B may include one or more of the following Elements: any one, more, or all of Elements 1, 2, 4, 6-11, 14, and 15; any one, more, or all of Elements 1, 3, 4, 6-11, 14, and 15; any one, more, or all of Elements 1, 2, 5, 6-11, 14, and 15; any one, more, or all of Elements 1, 3, 5, 6-11, 14, and 15.

To facilitate a better understanding of the embodiments of the present invention, the following examples of preferred or representative embodiments are given. In no way should the following examples be read to limit, or to define, the scope of the invention.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method of cleansing a healthcare device comprising:
providing a water-soluble dissolvable cleansing strip comprising:
a water-soluble carrier film; and
cleansing chemistry coated upon or embedded within the water-soluble carrier film, wherein the cleansing chemistry comprises at least one active ingredient selected from the group consisting of sodium tetraborate pentahydrate, an alkylpolyglycoside, ortho-benzyl-para-chlorophenol, para-tertiary amylphenol, 2-phenylphenol, and any combination thereof;
introducing the water-soluble dissolvable cleansing strip to an aqueous-based fluid;
dissolving the water-soluble dissolvable cleansing strip in the aqueous-based fluid, thereby releasing the cleansing chemistry into the aqueous-based fluid;
soaking the healthcare device in the aqueous-based fluid comprising the released cleansing chemistry, thereby cleansing the healthcare device.

2. The method of claim 1, wherein the healthcare device is a medical device or a dental device.

3. The method of claim 1, wherein the cleansing of the healthcare devices comprises one of cleaning the healthcare device, disinfecting the healthcare device, or sterilizing the healthcare device.

4. The method of claim 1, wherein the at least one active ingredient comprises a combination of at least sodium tetraborate pentahydrate and an alkylpolyglycoside.

5. The method of claim 1, wherein the at least one active ingredient comprises a combination of at least ortho-benzyl-para-chlorophenol, para-tertiary amylphenol, and 2-phenylphenol.

6. The method of claim 1, wherein the water-soluble carrier film is selected from the group consisting of an alcohol polymer, a polyacrylamide, a cellulose derivative, a polyvinylpyrrolidone, an acrylate polymer, an alginate, a glycerin, a protein, a gum, a polysaccharide, a sorbitol, a seaweed, a synthetic polymer, a polystyrene sulfonate, a polyampholyte, a polyethyleneimine, and any combination thereof and/or the water-soluble carrier film is selected from the group consisting of a polyvinyl alcohol, a polyethylene glycol, a polyacrylamide, a polyacrylic acid, and any combination thereof.

7. The method of claim 1, wherein the at least one active ingredient is present in an amount in the range of about 0.2 percent weight by total weight of the cleansing chemistry to about 10 percent weight by total weight of the cleansing chemistry.

8. The method of claim 1, wherein the cleansing chemistry further comprises at least one additive selected from the group consisting of a thickener, a surfactant, a preservative, or any combination thereof.

9. The method of claim 8, wherein the at least one additive is present in an amount in the range of about 0.1 percent weight by total weight of the cleansing chemistry to about 5 percent weight by total weight of the cleansing chemistry.

10. The method of claim 8, wherein:
the thickener is polypropylene glycol;
the surfactant is selected from the group consisting of an alkyl polyglycoside, a sodium tetraborate, ethanolamine, and any combination thereof; or
the preservative is selected from the group consisting of diazolidinyl urea, a paraben, and any combination thereof.

11. The method of claim 1, further comprising removing the water-soluble dissolvable cleansing strip from a protective packaging.

12. The method of claim 11, wherein the protective packaging is 100% recyclable and biodegradable.

13. A water-soluble dissolvable cleansing strip comprising:
a water-soluble carrier film; and
cleansing chemistry coated upon or embedded within the water-soluble carrier film, wherein the cleansing chemistry comprises at least one active ingredient selected from the group consisting of sodium tetraborate pentahydrate, an alkylpolyglycoside, ortho-benzyl-para-chlorophenol, para-tertiary amylphenol, 2-phenylphenol, and any combination thereof,
wherein the water-soluble dissolvable cleansing strip is dissolvable in an aqueous-based fluid to cleanse a healthcare device soaking therein.

14. The water-soluble dissolvable cleansing strip of claim 13, wherein the healthcare device is a medical device or a dental device.

15. The water-soluble dissolvable cleansing strip of claim 13, wherein the at least one active ingredient comprises a combination of at least sodium tetraborate pentahydrate and an alkylpolyglycoside.

16. The water-soluble dissolvable cleansing strip of claim 13, wherein the at least one active ingredient comprises a combination of at least ortho-benzyl-para-chlorophenol, para-tertiary amylphenol, and 2-phenylphenol.

17. The water-soluble dissolvable cleansing strip of claim 13, wherein the water-soluble carrier film is selected from the group consisting of an alcohol polymer, a polyacrylamide, a cellulose derivative, a polyvinylpyrrolidone, an acrylate polymer, an alginate, a glycerin, a protein, a gum, a polysaccharide, a sorbitol, a seaweed, a synthetic polymer, a polystyrene sulfonate, a polyampholyte, a polyethyleneimine, and any combination thereof; and/or the water-soluble carrier film is selected from the group consisting of a polyvinyl alcohol, a polyethylene glycol, a polyacrylamide, a polyacrylic acid, and any combination thereof.

18. The water-soluble dissolvable cleansing strip of claim 13, wherein the at least one active ingredient is present in an amount in the range of about 0.2 percent weight by total weight of the cleansing chemistry to about 10 percent weight by total weight of the cleansing chemistry.

19. The water-soluble dissolvable cleansing strip of claim 13, wherein the cleansing chemistry further comprises at least one additive selected from the group consisting of a thickener, a surfactant, a preservative, and any combination thereof.

20. The water-soluble dissolvable cleansing strip of claim 19, wherein the at least one additive is present in an amount in the range of about 0.1 percent weight by total weight of the cleansing chemistry to about 5 percent weight by total weight of the cleansing chemistry.

21. The water-soluble dissolvable cleansing strip of claim 19, wherein:
the thickener is polypropylene glycol;
the surfactant is selected from the group consisting of an alkyl polyglycoside, a sodium tetraborate, ethanolamine, and any combination thereof; or
the preservative is selected from the group consisting of diazolidinyl urea, a paraben, and any combination thereof.

22. The water-soluble dissolvable cleaning strip of claim 13, wherein the water-soluble dissolvable cleaning strip is contained within a protective packaging.

23. The water-soluble dissolvable cleaning strip of claim 22, wherein the protective packaging is 100% recyclable and biodegradable.
